(19) United States
(12) Patent Application Publication
(10) Pub. No.: US 2023/0210099 A1
(43) Pub. Date: Jul. 6, 2023

(54) FISHING TACKLE

(71) Applicant: Aaron Pierce, Cut Off, LA (US)

(72) Inventor: Aaron Pierce, Cut Off, LA (US)

(21) Appl. No.: 18/091,803

(22) Filed: Dec. 30, 2022

Related U.S. Application Data
(60) Provisional application No. 63/294,906, filed on Dec. 30, 2021.

(51) Int. Cl. A01K 85/00

(52) U.S. Cl. CPC A01K 85/1831; A01K 85/1811

(57) ABSTRACT

A fishing tackle comprising a hook with a protruding portion disposed on a shank of the hook and an artificial bait over-molded on the hook and protruding portion. The protruding portion includes a plurality of ridges disposed along a first section and second section. The ridges disposed along the first section are angled towards the proximal end of the hook, and the ridges disposed along the second portion are angled towards the distal end of the hook.

### RELATED APPLICATIONS

This application claims priority to U.S. Provisional Application No. 63/294,906 filed Jan. Dec. 30, 2021. The entire contents of the above applications are hereby incorporated by reference as though fully set forth herein.

### FIELD OF TECHNOLOGY

The present invention relates in general to fishing tackle, and in particular to artificial fishing bait and lures.

### BACKGROUND

Fishing tackle consists of all the equipment that is used in the sport of fishing, such as fishing rods, lines, hooks, and bait. When it comes to bait and lures, anglers have been using various types of artificial equipment designed to mimic live bait in order to attract fish. One reason these artificial lures are an attractive choice is because, unlike live bait, they can be used over and over again to catch several fish. The longevity and durability of these artificial lures continues to drive innovation and anglers are constantly looking for new methods to increase the durability and lifespan and attractiveness of their lures.

Many artificial lures consist of a hook and some form of soft plastic artificial bait. The bend of the hook is threaded through the bait head end, such as an eyelet, until the bait is positioned along the shank of the hook and the throat of the hook end remains exposed. When a fish is hooked, bilateral forces applied on the lure create tension and cause the artificial bait to slide along the shank of the hook, and in many instances, the bait may become dislodged from the hook. Some hooks in the art are equipped with protrusions that are configured to allow an artificial bait to slide onto the hook, but these embodiments only prevent lateral resistance in one direction. Accordingly, there is a need in the art for creating a fishing lure that is designed to prevent lateral motion in both directions of the artificial bait along the hook.

### BRIEF SUMMARY OF THE INVENTION

It is an object of this invention to create an artificial fishing lure that minimizes displacement of the artificial bait along the hook. The fishing lure comprises a hook having a proximal end, a distal end, and a plurality of ridges or fins disposed along a length of the shank of the hook between the proximal end and the distal end. In one embodiment, in the first section, the ridges are angled towards the proximal end of the hook, or the hook eyelet, while in the second section, the ridges are angled towards the distal end, or the hook bend. The bait is molded over the ridges such that the angled ridges provide resistance to movement of the bait in either direction along the hook.

### BRIEF DESCRIPTION OF THE DRAWINGS

FIG. 1 is an isometric side view of the fishing lure in accordance with the embodiments of the invention showing the protruding portion for the hook.

FIG. 2 is an alternative isometric side view of the fishing lure in accordance with the embodiments of the invention showing the protruding portion for the hook.

FIG. 3 is a bottom view of the fishing lure in accordance with the embodiments of the invention showing the protruding portion for the hook.

FIG. 4 is a cross-sectional side view of the fishing lure in accordance with the embodiments of the invention showing the protruding portion for the hook.

FIG. 5 is an isometric view of the fishing lure in accordance with the embodiments of the invention showing the protruding portion on the hook.

FIG. 6 is an isometric view of the fishing lure in accordance with the embodiments of the invention showing the artificial bait molded over the hook.

FIG. 7 is an exploded view of the fishing lure in accordance with the embodiments of the invention showing the artificial bait, the hook, and the protruding portion for the hook.

### DETAILED DESCRIPTION

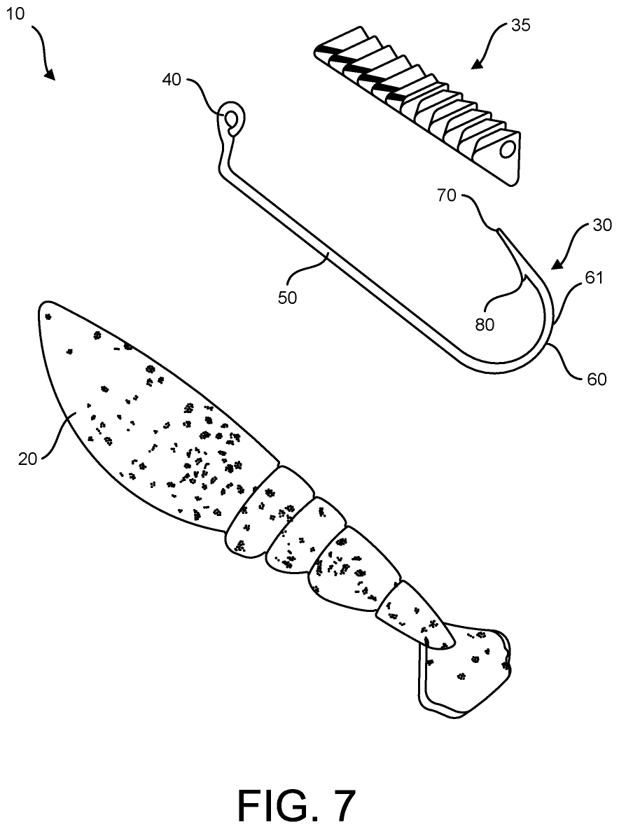

FIG. 7 shows an exploded view of the improve fishing lure 10 with artificial bait 20 and a hook 30, both features are well known in the art and can take on a variety of forms and shape, and the protruding portion 35. A typical hook includes an eye or eyelet 40, a shank 50, a bend 60, and throat 61 that terminates at a point 70 and may or may not include a barb 80. The protruding portion 35 is fixedly attached to the shank 50 of the hook, and the protruding portion 35 and hook shank 50 are embedded in the bait 20 of the lure. The bait 20 is typically molded over the hook shank 50 and the protruding portion 35. The eye 40 of the hook 30 and throat 61 leading up to the point 70 are exterior to the bait 20.

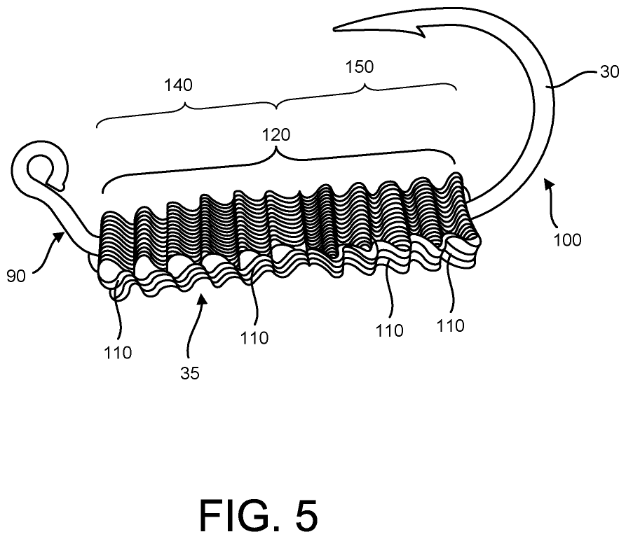

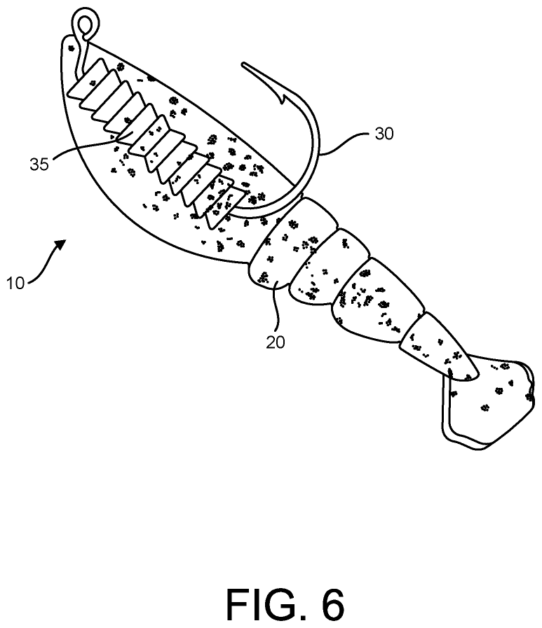

Turning to FIGS. 5-6, the fishing lure 10 disclosed in this application includes an artificial bait 20 and a hook 30 along with a protruding portion 35 that is disposed along a length 120 of the hook shank 50. Typical length can be from 2 cm to 10+ cm, depending on the lure. The protruding portion 35 may be secured to the hook 30 by various means known in the art, including for example, being molded over the hook 30 or pre-molded as part of the hook 30, or welded or glued to the shank 50 after threading the hook shank 50 through opening 130 of the protruding portion 35. Alternatively, for instance, with a hard rigid bait, the underside of the bait may include a reverse profile of the protruding portion 35, into which the protruding portion 35 and shank 50 may be fixedly joined to, such as by an adhesive.

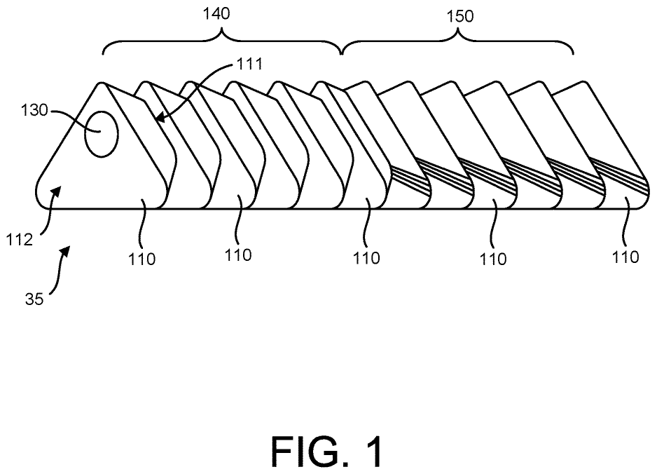

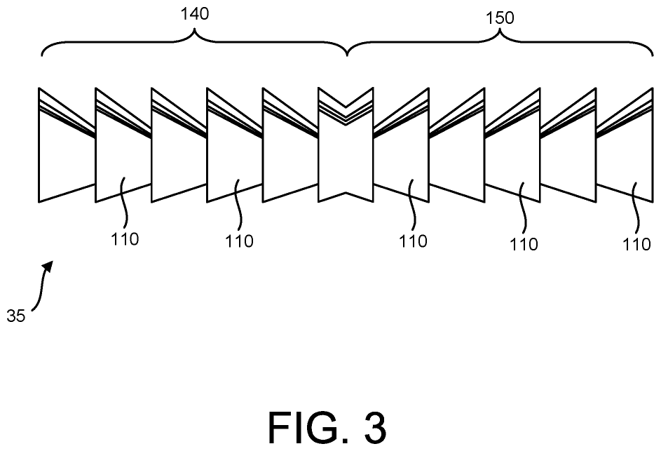

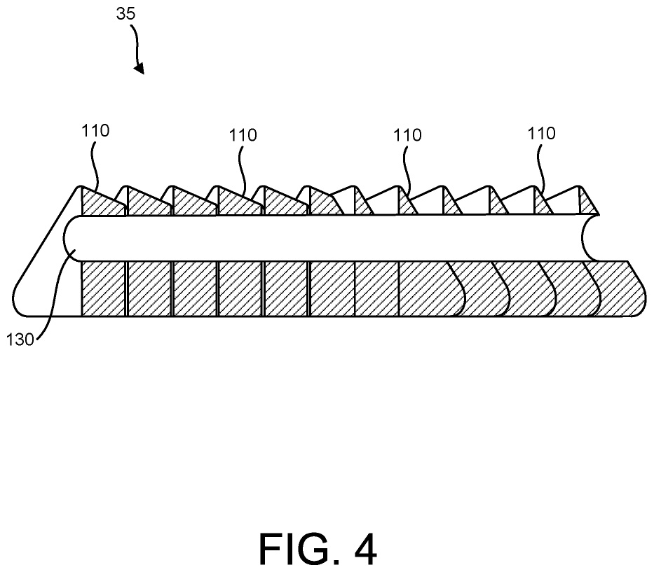

As shown in FIGS. 1-5, the protruding portion 35 comprises a plurality of ridges 110 (or other protrusions, such as fins) that are disposed, in a preferred embodiment, circumferentially around the shank 50 of the hook 30. Alternatively, the protruding portion 35 may be disposed on one side of the shank 50 or on multiple sides of the shank 50. As shown in FIG. 3, the protruding portion 35 includes a first section 140 and a second section 150, each having ridges or protrudin fins 110 that are angled in opposite directions. In the preferred embodiment, and as shown in FIG. 5, the protruding portion is divided in roughly equal parts between the first section 140 and the second section 150, with the ridges 110 of the first section 140 being angled toward the proximal section, the eye, and the ridges 110 of the second section 150 being angled the distal end 100 of the hook 30, or the bend end 60. The direction of the angle is set by the widest portion or the closest portion of the ridge. For instance, if the ridge's widest or closest portion faces the eye 40 or proximal end of the hook, the ridge 110 is angled toward the proximal end or eye end of the hook 30.

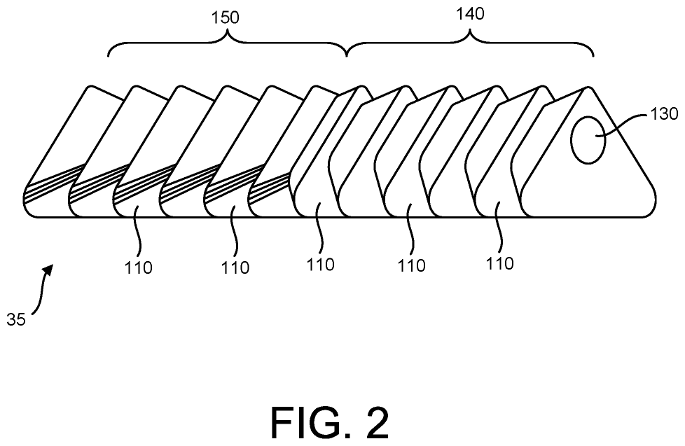

For purposes of this application, these ridges 110 can be circumferential ridges, or other shapes and configuration, such as fins, or other shapes that present an edge at the end of the ridge directed to the bend 60 of the hook in the second section 150 and directed to the eye 40 or proximal end of the hook 30 in the first section 140. The extent or height a (measured from the hook) and thickness of each ridge 110 can be several millimeters up to several centimeters, with both dependent on the thickness and height of the of the completed lure, which is related to the target fish size. The height of each ridge 110 does not have to match. Indeed, the height in a solid form ridge 110 can vary through the ridge 110, such as shown in FIGS. 1-3. For instance, the heights can vary so the exterior of the ridges 110 on one side (or both sides) ridge is tilted forming the angle, which can be about 15 degrees to 85 with the same range on the opposed side of the protruding portion 120 similar to but of opposite direction. If the angle is formed by the exterior surface of a ridge, such as in a tapered ridge, the ridge 110 itself is not angled or tilted, the tilt of the ridges 110 themselves can be zero, such as shown in FIGS. 1-4. The angle of the ridge exterior, such as for a tapered ridge body, can be from 10 degrees to 80 degrees. The angles do not have to match, but it is preferred. The distance between the ridges on the shaft will depend on the shape of the ridge 110, but there should be sufficient space between the top of adjacent ridges 110 to allow the bait material, in the molding process to flow into and fill the gap between adjacent ridges 110 to prevent the bait 20 from sliding along the protruding portion when a fish is hooked on the lure. For instance, the ridges 110 in FIG. 1 are tapered sections, with each ridge 110 having a top portion 111 and a bottom portion 112, where the ridge 110 tapers or thins from the wider bottom portion 112 to the thinner top portion 111. The ridges abut, with the larger bottom portion 112, in the first section of the protruding portion 120, facing the eye 40 end or proximal end of the hook 30, and in the second section 150 of the protruding portion 120, the larger bottom end of the ridge 110 faces the distal end of the hook 30. This arrangement creates a sawtooth profile leaving a gap between adjacent ridges 110 top ends forming the “teeth” in the saw-toothed profile. The sawtooth profile in the first section 140 has the ridges or “teeth” 110 directed in the opposite direction as the sawtooth profile of the second section 150. It is apparent that this reversal in sawtooth profile between the two sections 140,150 could be accomplished by reversing the directions of each section profile. For instance, by having ridges 110 in the first section 140 angled towards the bend 60 in the hook, and the ridges 110 of the second section 150 angled toward the distal end or eye 40 of the hook. In either case, the angled ridges forms a gap or space between adjacent ridges. This gap is the volume into which molten or liquid bait material can flow in the bait molding process. FIG. 3 is comparable, where the ridges are abutting sections of a clone, again forming a circumferential sawtooth profile. FIG. 2 is the same structure depicted in FIG. 1 and each shows the ridge through hole 130, where each ridge 110 has a ridge through hole 130 with all are aligned forming a protrusion through hole. Each ridge opening 130 is sized to allow the eye end or proximal end of the hook to pass the through the protrusion through opening to place the shaft of the hook internal to the protruding portion The hook shaft can then be secured to the protruding portion by using an adhesive type of material.

In order to secure the bait 20 over the protruding portion 35 and the hook 30, the bait 20 is molded over the hook 30 with attached protruding portion 35 such that the liquid or molten bait material fills the spacing between the ridges 110 in both the first section 140 and second section 150, with the liquid bait material filling the mold to form the completed lure, where the eye end of the hook 30 and the bend end of the hook are located exterior to the mold. The sawtooth profile of the ridges 110 in opposing directions provides added resistance to the forces acting on the lure 20 to slide the bait off the hook.

The lure 20 is formed by inserting the preformed hook 30 and protruding portion 35 into a mold and adding liquid or molten bait material into the mold, which after setting forms the complete lure 20. The lure 20 can have a hard shell such as by using a two-part resin that hardens after setting, such as fiberglass or certain plastics. For a soft flexible lure, soft plastics, or silicon can be used as the bait material. In each case, the preformed protruding portions 35 must be made of material that has a melt temperature higher than the bait material. The protruding portion 35 can also be formed by molding, and the hook 30 can be placed in the mold in proper orientation. Alternatively, the individual ridges may be manufactured and adhesively bound to each other. If the individual ridges are physically separated, a base or foot section is needed onto attach the separated ridges.

For the purposes of promoting and understanding of the principles of the invention, reference has been made to the preferred embodiments illustrated in the drawings, and specific language has been used to describe these embodiments. However, this specific language intends no limitation of the scope of the invention, and the invention should be construed to encompass all embodiments that would normally occur to one of ordinary skill in the art. For instance, while not preferred but within the scope of the invention, the ridges disposed on the first section 140 of the protruding section are described as angled towards the distal end or eye 40 of the hook, the eye end, and the ridges disposed along the second section 150 are angled towards the proximal end of the hook, or the bend 30. This relationship could be reversed, so that the angled ridges face each other. The particular implementations shown and described herein are illustrative examples of the invention and are not intended to otherwise limit the scope of the invention in any way.

For the sake of brevity, conventional aspects of the system (and components of the individual operating components of the system) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. A fishing tackle lure comprising:
a hook having a proximal end and a distal end, and a protruding portion disposed along a length of the hook between the proximal end and the distal end,
wherein the protruding portion comprises a plurality of ridges,
wherein the protruding portion comprises a first section and a second section,
wherein the ridges disposed along the first section are angled towards the proximal end of the hook, and
wherein the ridges disposed along the second section are angled towards the distal end of the hook.

2. The fishing lure of claim 1 where the hook shank is embedded in the protruding portion.

3. The fishing tackle lure of claim 1 where the hook is fixedly attached to the protruding portion.

4. A fishing tackle comprising:
a bait, and a
a hook having a proximal end terminating in an eyelet, and a distal end having a bend section and a throat section terminating in a barb or a point, and a shank portion between the distal end and proximal end with a protruding portion disposed on the shank portion,
wherein the protruding portion comprises a plurality of ridges,
wherein the protruding portion comprises a first section and a second section,
wherein the ridges disposed along the first section are angled towards the proximal end of the hook, and
wherein the ridges disposed along the second section are angled towards the distal end of the hook.

5. The fishing tackle lure of claim 4 wherein each ridge forms a tapered body having a top portion and a bottom portion where the ridge thins or tapers from the bottom portion to the top portion, and wherein the ridges disposed on the second section have the bottom portion of each ridge facing the distal end of the hook, and wherein the ridges disposed on the first section have the bottom portion of each ridge facing the proximal end of the hook.

6. The fishing tackle lure of claim 5 where adjacent ridges in each section abut one another.

7. The fishing lure of claim 4 where each ridge in each section has a ridge through hole with each ridge through hole aligned defining a protruding through hole.

8. The fishing tackle of claim 7 where the shank portion is positioned in the protruding through hole.

9. The fishing tackle lure of claim 5 wherein each ridge defines a section of a cone or a section of a pyramid.

10. The fishing tackle lure of claim 4 where the bait forms a hard rigid substance.

11. The fishing tackle lure of claim 4 where the bait forms a soft flexible substance.

12. The fishing tackle lure of claim 4 where in the bait surrounds the protruding portion.

13. The fishing tackle lure of claim 12 where the bait has an outer surface, and the hook eyelet, the hook throat and the hook barb or hook point are located exterior to the bait outer surface.

14. The fishing tackle lure of claim 4 where the angled ridges form a gap between adjacent ridges, and the gap is filled with bait.
